(19) United States
(12) Patent Application Publication
(10) Pub. No.: US 2025/0211846 A1
(43) Pub. Date: Jun. 26, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventors: AYUMI NAKAGAWA, TOKYO (JP); MANABU FUJIKI, TOKYO (JP)

(21) Appl. No.: 18/849,435

(22) PCT Filed: Feb. 2, 2023
(86) PCT No.: PCT/JP2023/003399

§ 371 Date: Sep. 20, 2024

(30) Foreign Application Priority Data
Mar. 29, 2022 (JP) 2022-053428

(51) Int. Cl. H04N 23/60; G06F 3/01

(52) U.S. Cl. CPC H04N 23/60; G06F 3/016

(57) ABSTRACT

[Object] To provide an information processing apparatus, an information processing method, and a program that are capable of presenting pseudo shutter vibration.

[Solving Means] An information processing apparatus includes a control unit that performs, on the basis of vibration data of a shutter of an imaging apparatus from which the vibration data is acquired, control to generate input waveform data of pseudo shutter vibration to be presented in a target apparatus by referring to a parameter of the target apparatus.

### TECHNICAL FIELD

The present disclosure relates to an information processing apparatus, an information processing method, and a program.

### BACKGROUND ART

In recent years, mechanical shutters, which adjust the amount of light received by physically opening and closing the shutter, have been on the decline, and electronic shutters, which change the amount of light received by electronically controlling the exposure time, such as mirrorless single-lens reflex cameras, have become the mainstream.

### CITATION LIST

### Patent Literature

Patent Literature 1: Japanese Patent Application Laid-open No. 2019-98231

### DISCLOSURE OF INVENTION

### Technical Problem

However, in a case of an electronic shutter, the shutter vibration, which is conventionally generated by a mechanical shutter, is not generated, and the emotional value of a user may be reduced. Patent Document 1 above discloses a method of generating an audio signal that causes a vibration generation apparatus to generate vibration in accordance with the movement of an object, but it does not mention the generation of a signal for presenting shutter vibration.

### Solution to Problem

According to the present disclosure, there is provided an information processing apparatus including a control unit that performs, on the basis of vibration data of a shutter of an imaging apparatus from which the vibration data is acquired, control to generate input waveform data of pseudo shutter vibration to be presented in a target apparatus by referring to a parameter of the target apparatus.

Moreover, according to the present disclosure, there is provided an information processing method including by a processor, performing, on the basis of vibration data of a shutter of an imaging apparatus from which the vibration data is acquired, control to generate input waveform data of pseudo shutter vibration to be presented in a target apparatus by referring to a parameter of the target apparatus.

Moreover, according to the present disclosure, there is provided a program that causes a computer to function as a control unit that performs, on the basis of vibration data of a shutter of an imaging apparatus from which the vibration data is acquired, control to generate input waveform data of pseudo shutter vibration to be presented in a target apparatus by referring to a parameter of the target apparatus.

### BRIEF DESCRIPTION OF DRAWINGS

FIG. 1 A view describing an overview of the presentation system of pseudo shutter vibration according to an embodiment of the present disclosure.

FIG. 2 A block diagram showing an example of a configuration of a generation apparatus according to the present embodiment.

FIG. 3 A view describing an example of a tool for measuring vibration data of a shutter of a camera according to the present embodiment.

FIG. 4 A view describing generation of input waveform data based on acceleration data according to the present embodiment.

FIG. 5 A view showing an example of an impression of a shutter feeling and the corresponding vibration parameter type according to the present embodiment.

FIG. 6 A view showing an example of a screen for specifying the impression of the shutter feeling according to the present embodiment.

FIG. 7 A block diagram showing an example of a configuration of a presentation apparatus according to the present embodiment.

FIG. 8 A flowchart showing an example of a flow of processing of generating input waveform data according to the present embodiment.

FIG. 9 A flowchart showing an example of a flow of processing of outputting a shutter sound corresponding to a subject type according to a modified example of the present embodiment.

### MODE(S) FOR CARRYING OUT THE INVENTION

Hereinafter, favorable embodiments of the present disclosure will be described in detail with reference to the accompanying drawings. It should be noted that in this specification and the drawings, components having substantially the substantially same functions and configurations will be denoted by the same reference signs and duplicate descriptions thereof will be omitted.

Moreover, the descriptions will be given in the following order.
1. Overview
2. Configuration Example
   2-1. Configuration of Generation Apparatus 20
   2-2. Configuration of Presentation Apparatus 30
3. Operation Processing
4. Modified examples
5. Supplement

### 1. Overview

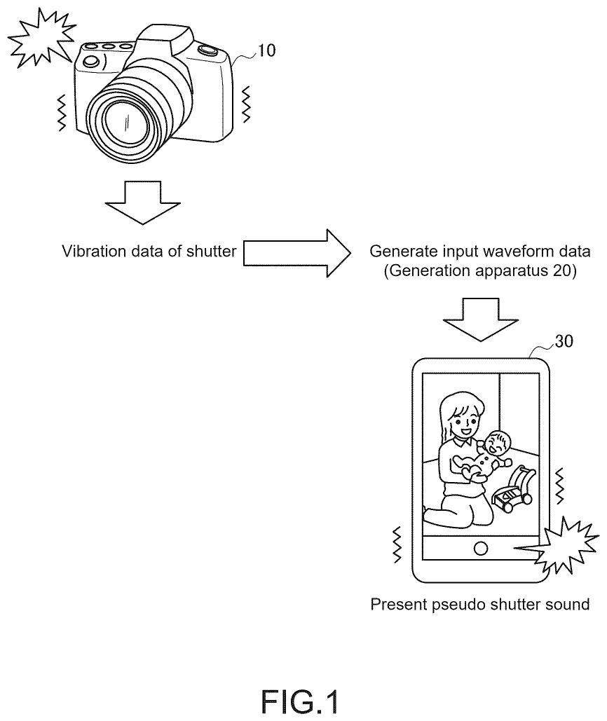

FIG. 1 is a view describing an overview of a presentation system of pseudo shutter vibration according to an embodiment of the present disclosure. The presentation system according to the present embodiment includes a camera 10, which is an example of an imaging apparatus from which data is acquired, an generation apparatus 20 (an example of an information processing apparatus) that generates input waveform data for presenting vibration on the basis of the vibration data of the shutter acquired from the camera 10, and a presentation apparatus 30 (an example of a target apparatus) that presents pseudo shutter vibration through a built-in vibration unit by using the generated input waveform data.

The camera 10 has a mechanical shutter (shutter mechanism). Various sensors are used for acquiring data about the shutter vibration (vibration data) generated in the camera 10, which will be described in detail later. In the present embodiment, acceleration data is used as an example of the vibration data.

The generation apparatus 20 generates input waveform data for presenting pseudo shutter vibration on the basis of the vibration data acquired from the camera 10 and external parameters. The input waveform data is a signal to be used for driving the vibration unit provided in the presentation apparatus 30. The external parameters include at least parameters of the presentation apparatus 30 (target apparatus). The generation apparatus 20 may be a server, a smartphone, a portable phone terminal, a tablet terminal, a personal computer (PC), or the like. Moreover, the generation apparatus 20 may be realized by the presentation apparatus 30.

The presentation apparatus 30 is an apparatus having an imaging function using an electronic shutter. The presentation apparatus 30 includes an imaging unit and a vibration unit and performs control to present pseudo shutter vibration through the vibration unit by using the input waveform data generated by the generation apparatus 20 in accordance with a shutter timing in the imaging unit. The presentation apparatus 30 may be, for example, an electronic shutter type camera (so-called digital camera), a smartphone/mobile phone terminal/tablet terminal with a camera function, or a wearable device such as a smart watch or a neck-type camera with a camera function. In addition, the above camera function means a camera function that can be used in a smartwatch or a wearable device such as a neck-type camera. Moreover, the camera function mentioned above may be an augmented reality (AR) camera.

### (Organizing Issues)

As mentioned above, the electronic shutter does not generate the shutter vibration that is conventionally generated by the mechanical shutter, which may reduce the emotional value of a user.

In the present embodiment, it is possible to present pseudo shutter vibration. Specifically, a signal for presenting pseudo shutter vibration is generated on the basis of vibration data obtained by sensing actual shutter vibration from the camera 10. This makes it possible to reproduce shutter vibration of the camera 10 from which the vibration data has been acquired or to present shutter vibration according to the user's preference in an electronic shutter type apparatus (presentation apparatus 30), thereby enhancing the emotional value.

Hereinabove, the overview of the presentation system according to the embodiment of the present disclosure has been described. Next, specific configurations of the generation apparatus 20 and the presentation apparatus 30 included in the presentation system according to the present embodiment will be described with reference to the drawings.

### 2. Configuration Example

### 2-1. Configuration of Generation Apparatus 20

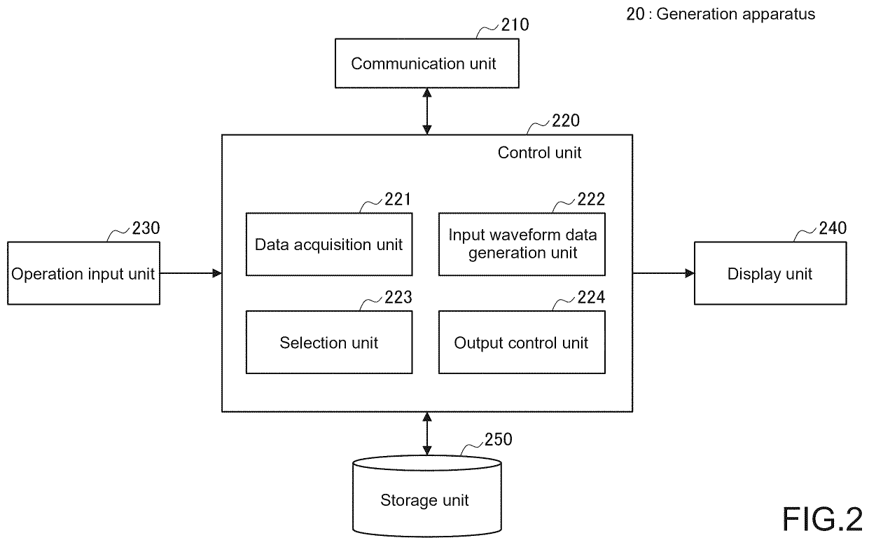

FIG. 2 is a block diagram showing the generation apparatus 20 according to the present embodiment. As shown in FIG. 2, the generation apparatus 20 (information processing apparatus) includes a communication unit 210, a control unit 220, an operation input unit 230, a display unit 240, and a storage unit 250.

### (Communication Unit 210)

The communication unit 210 is connected to external devices and transmits/receives data from/to them. For example, the communication unit 210 sends and receives data to and from the camera 10 and the presentation apparatus 30. Moreover, the communication unit 210 can be connected to a network for communication via, for example, wired/wireless local area network (LAN), Wi-Fi (registered trademark), Bluetooth (registered trademark), mobile communication network (long term evolution (LTE)), 3rd generation mobile communication method (3G)), 4th generation mobile communication system (4G), or 5th generation mobile communication system (5G)).

### (Control Unit 220)

The control unit 220 functions as an arithmetic processor and a controller and controls the overall operation in the generation apparatus 20 in accordance with various programs. The control unit 220 is realized by electronic circuits such as central processing unit (CPU) and microprocessor. Moreover, the control unit 220 may include a read only memory (ROM) for storing the programs and calculation parameters to be used and a random access memory (RAM) for temporarily storing variable parameters as appropriate.

The control unit 220 according to the present embodiment also functions as a data acquisition unit 221, an input waveform data generation unit 222, a selection unit 223, and an output control unit 224.

The data acquisition unit 221 has a function of acquiring various types of data to be used for generating input waveform data. First of all, the data acquisition unit 221 acquires vibration data of the shutter sensed by various sensors from the camera 10. There are various methods to detect the vibration data.

For example, an inertial measurement unit (IMU) sensor installed in the camera 10 may acquire acceleration data as vibration data and send it to the generation apparatus 20. In this case, an application for sensing may be prepared in advance and downloaded to the camera 10. With such an application, the camera 10 may output a message such as “Please press the shutter release button” through a display or speaker of the camera 10. Moreover, the application may inform the user of points to be considered in sensing (e.g., how to hold the camera 10, camera shake). Moreover, when such an application detects camera shake, a message such as “Camera shake is detected. Please release the shutter carefully may be displayed to obtain the shutter vibration more accurately. Moreover, here it is assumed that the camera 10 is an imaging apparatus owned by the user and that the user performs the sensing operation of the shutter vibration of the camera 10, but the present embodiment is not limited thereto. Vibration data acquired by a third party (an individual or a manufacturer) may be made public in an archive on a server. In the archive, the model of the camera from which the vibration data has been acquired and photographs may also be made public. The user may make an operation of downloading any vibration data from the server to the generation apparatus 20.

Moreover, vibration data can also be obtained from the blurring of the captured image. The camera 10 may extract the vibration data from the blurred image by using the image sensor.

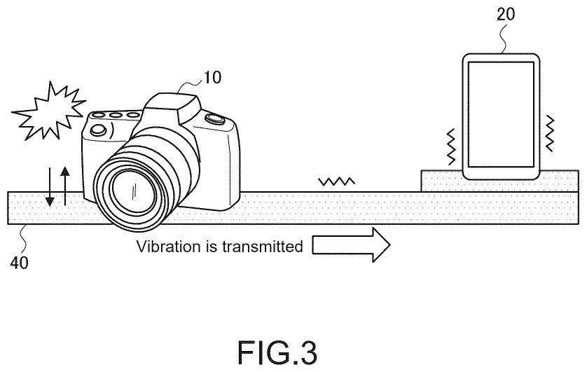

Moreover, the vibration data can be sensed not only by internal sensors (e.g., IMU sensor, accelerometer, image sensor) built in the camera 10, but also by external sensors. FIG. 3 is a view describing an example of a tool for measuring vibration data of a shutter of the camera 10 according to the present embodiment. As shown in FIG. 3, the camera 10 is placed on one end of a measurement tool 40, which is constituted by a sheet-like rigid plate, and a sensor apparatus (e.g., the generation apparatus 20) with a built-in IMU sensor or acceleration sensor is placed on the other end. In this state, the camera 10 generates shutter vibration and the sensor of the generation apparatus 20 acquires acceleration a′. The generation apparatus 20 may calculate acceleration a′ generated in the camera 10 on the basis of the acquired acceleration a′, weight w of the camera 10 (detected by a weight sensor built in the camera 10 or obtained on the basis of a model number or the like of the camera 10), and a characteristic parameter k of the sheet in accordance with the following equation and obtain it as vibration data.

$$a = {a}^{′} * w * k \qquad ( Equation )$$

Moreover, the data acquisition unit 221 acquires external parameters to be used for generating input waveform data and stores it in the storage unit 250. The external parameters include, for example, parameters of the camera 10 (imaging apparatus) and the presentation apparatus 30 (target apparatus). The data acquisition unit 221 may acquire the parameters of the camera 10 from the camera 10 via the communication unit 210 or may acquire the parameters of the presentation apparatus 30 via the communication unit 210. Moreover, the data acquisition unit 221 may retrieve the parameters of each apparatus from the storage unit 250 or an external device (e.g., server) on the basis of the model name or model number of the camera 10 or the presentation apparatus 30. Moreover, the data acquisition unit 221 may also acquire user preference information and user characteristics (e.g., age, gender, medical condition) as external parameters. The user preference information and user characteristics may be input by the user, for example, through the operation input unit 230.

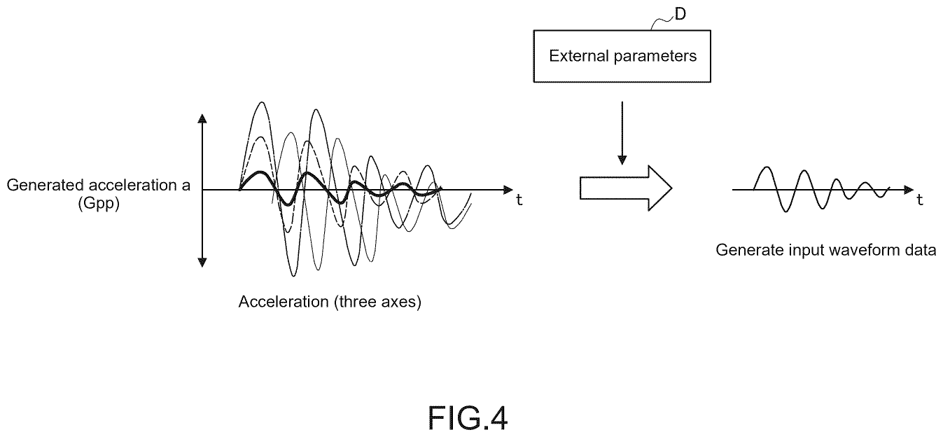

The input waveform data generation unit 222 has a function of generating input waveform data used for presenting pseudo shutter vibration on the basis of the vibration data (acceleration data as an example) of the shutter of the camera 10 from which the vibration data has been acquired. FIG. 4 is a view describing generation of input waveform data based on the acceleration data according to the present embodiment. In the present embodiment, the acceleration data (generated acceleration a shown on the left-hand side in FIG. 4) obtained by sensing actual shutter vibration generated by the camera 10 and external parameters D are used for generating pseudo vibration data of the shutter in the presentation apparatus 30.

The parameters of the presentation apparatus 30 (target apparatus) can be data related to the shutter vibration presentation, such as the weight of the presentation apparatus 30, structure, lens type (e.g., lens weight, size), power consumption, specification data (specifications) of the vibration unit, and an influence threshold. The specification data of the vibration unit includes, for example, frequency characteristics, a rated voltage, direction of vibration, and a used frequency band (specific used frequency band value and also information indicating whether it is a single frequency or broad-band frequencies). Moreover, the parameters of the camera 10 include the weight of the camera 10, structure, lens type, and how to hold the camera 10 during vibration sensing, and the like.

The input waveform data generation unit 222 may process the acquired acceleration data by referring to the parameters of the presentation apparatus 30 (target apparatus) and generate, from the processed acceleration data, input waveform data for reproducing a shutter feeling of the camera 10 (for generating pseudo shutter vibration) in the presentation apparatus 30 (target apparatus). For example, the input waveform data generation unit 222 processes the acceleration data as appropriate so that a shutter feeling similar to that of the camera 10 can also be obtained in the presentation apparatus 30, depending on the parameters of the camera 10 and the parameters of the presentation apparatus 30. In the processing, for example, increase or decrease of the amplitude of the acceleration data and frequency adjustment using a period, a waveform, and Fourier transform processing may be performed. As an example, in a case where the weight of the presentation apparatus 30 is lighter than that of the camera 10, the acceleration data may cause the presentation apparatus 30 to vibrate too much in a case where the sensed acceleration data is used as is. Therefore, the acceleration is reduced. In addition to the weight, the structure, lens type, and specifications of the vibration unit may also affect the vibration, and therefore various parameters are used as appropriate.

Then, the input waveform data generation unit 222 generates input waveform data (signal for driving the vibration unit) on the basis of the processed acceleration data. For example, the input waveform data generation unit 222 may generate input waveform data corresponding to the processed acceleration data by combining sine wave, square wave, and the like. Moreover, the input waveform data generation unit 222 may select a waveform having characteristics similar to the processed acceleration data from the pre-generated waveforms and adjust the amplitude, for example.

It should be noted that it is difficult to reproduce a shutter feeling identical to that of the camera 10, depending on the structure of the presentation apparatus 30, constraints (e.g., power consumption and influence threshold), specifications of the vibration unit, and the like. Therefore, the term “reproduction” in the present embodiment includes making the shutter feeling closer to the shutter feeling of the camera 10. The input waveform data generation unit 222 may assign a score value of reproducibility to the generated input waveform data.

Moreover, the input waveform data generation unit 222 may analyze the frequency of the acquired acceleration data, process the frequency characteristics obtained by the analysis by referring to the parameters of the presentation apparatus 30 (target apparatus) (e.g., adjusting the distribution for each frequency component), and generate input waveform data for reproducing the shutter feeling of the camera 10 (for generating pseudo shutter vibration) in the presentation apparatus 30 on the basis of the processed frequency characteristics. For example, the input waveform data generation unit 222 may simulate vibration (e.g., using generated acceleration at each frequency) by referring to the parameters of the camera 10 and the parameters of the presentation apparatus 30 and generate the processed frequency waveform data.) and generate input waveform data corresponding to the processed frequency characteristics. As in the above, for generation of the input waveform data, sine waves or the like may be combined or adjustment or the like of the amplitude of the pre-generated waveforms may be performed. Moreover, as in the above, a reproducibility score value may be assigned to the generated input waveform data.

It should be noted that the acceleration data of the camera 10 to be used for generating input waveform data may be 3-axis composite acceleration. Moreover, a specific acceleration axis selected by the user among three axes (X-axis, Y-axis, and Z-axis) may be used. The selection of the acceleration axis to be used is an example of user preference information.

Moreover, the input waveform data generation unit 222 may be used after correcting the acceleration data in accordance with how to hold the camera 10 when the acceleration data has been sensed from the camera 10 (after making a correction to eliminate the influence on sensing due to the hold of the camera 10).

Moreover, the input waveform data generation unit 222 may generate input waveform data in a range below the influence threshold by referring to the influence threshold of the presentation apparatus 30. The influence threshold is a value indicating the possibility of undesirable influences (e.g., influence on the image sensor (e.g., blurring), generation of sound (e.g., audible sound)). Specifically, the input waveform data generation unit 222 changes intensity of vibration, a direction of vibration, a used frequency band, a duration of vibration, or an effect in the input waveform data to be lower than an influence threshold value.

Moreover, the input waveform data generation unit 222 may modify the input waveform data in accordance with user characteristics. For example, depending on the user's age or medical condition (which affects the sense of touch), the user may perceive different intensity or texture of the vibration even in a case where the same vibration is presented. The input waveform data generation unit 222 changes the intensity, direction, frequency band, duration, or effect of the vibration in the input waveform data on the basis of the user's age or medical condition so that the user can perceive a desired vibration (shutter vibration).

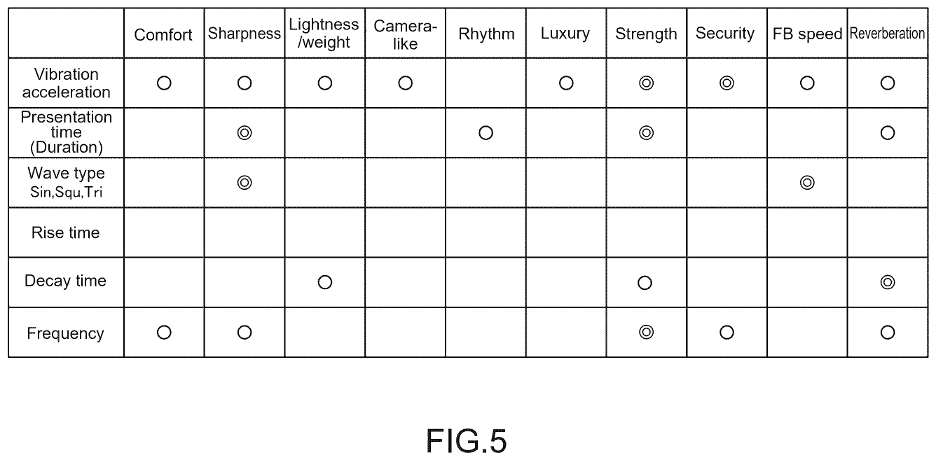

Moreover, the input waveform data generation unit 222 may generate (modify) input waveform data in accordance with a (degree of) impression of a shutter feeling specified by the user. FIG. 5 shows an example of a vibration parameter type corresponding to the impression of the shutter feeling according to the present embodiment. As shown in FIG. 5, for example, the impression of the shutter feeling includes comfort, sharpness, lightness/weight, camera-like, rhythm, luxury, strength, security, feedback (FB) speed, and reverberation. Moreover, the vibration parameter types that affect each impression are, for example, vibration acceleration, presentation time (duration), wave type (e.g., sine, square, triangle), rise time, decay time, and frequency.

In the example shown in FIG. 5, items that have an influence on the impression are circled and items that have a larger influence are double circled. For example, as the vibration acceleration is decreased, the overall features are filtered out, and the impression tends to be blurred (or degraded). Moreover, the longer the presentation time is, the more the reverberation appear and the more the sharpness tends to be lost. Moreover, the sharpness and the FB speed tend to increase when a square wave is used. Moreover, the sensitivity of intensity changes when the rise time is changed. Moreover, at 400 Hz to 100 Hz, the comfort and sharpness tend to increase as the frequency is increased, while the reverberation tends to decrease. Moreover, the sensitivity of intensity changes as the frequency is varied. The input waveform data generation unit 222 changes the vibration parameter types in the input waveform data in accordance with the impression specified by the user. It should be noted that the impressions shown in FIG. 5 and the influence in each item of the vibration parameter types are only examples, and the present embodiment is not limited thereto.

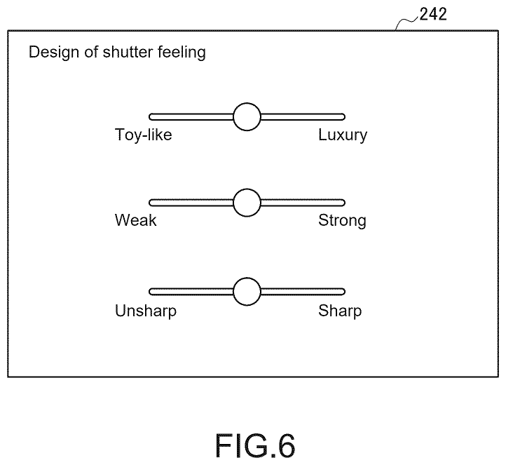

The control unit 220 can perform control to display on the display unit 240 a screen for specifying the impression of the shutter feeling as described above. FIG. 6 is a figure showing an example of a screen for specifying the impression of the shutter feeling according to the present embodiment. A screen 242 shown in FIG. 6 can be displayed on a display unit 350. On the screen 242, the user can select the degree of impression in the form of a slider. This allows the user to specify, for example, whether the impression should be more luxurious or more toy-like and also specify the degree of intensity and sharpness/unsharpness. It should be noted that FIG. 6 shows the specification screen in the form of a slider as an example, but the specification screen may be in the form of a radar chart or may be in the form that allows the user to select an impression word. Moreover, it is possible to disable the selection of impressions that are contrary to the specified impression.

Moreover, assuming that the presentation apparatus 30 is used by a family, the input waveform data generation unit 222 may generate input waveform data with a more toy-like impression in a case where the user is a child (e.g., in a case where “child” is selected). In a case where the user is an elderly person, the input waveform data generation unit 222 may generate input waveform data with an impression with enhanced sharpness and strength.

Hereinabove, the input waveform data generation method according to the present embodiment has been described in detail. The input waveform data generation unit 222 may generate a single piece of input waveform data by a predefined method or may generate a plurality of pieces of input waveform data as candidates for selection by several methods or combined methods.

In a case where the input waveform data generation unit 222 has generated a plurality of pieces of input waveform data (candidates), the selection unit 223 determines a piece of input waveform data selected by the user as the input waveform data to be used in the presentation apparatus 30. For example, the selection unit 223 displays a plurality of pieces of input waveform data on the display unit 240 and receives the user's selection. In this case, the input waveform data may be displayed by priority to encourage the user to make a selection. For example, the input waveform data (of shutter vibration) generated with priority on the strength, the input waveform data (of shutter vibration) generated with priority on the texture, the input waveform data (of shutter vibration) generated with priority on the prevention of camera shake, the input waveform data (of shutter vibration) generated with priority on the feeling depending on the user's age and the like. input waveform data, or the like., which are generated by prioritizing the hand feeling according to the user's age, or the like. Moreover, the selection unit 223 may display the input waveform data in order of the reproducibility score.

The output control unit 224 performs control to output the generated input waveform data to a storage destination or the target apparatus (presentation apparatus 30). The storage destination may be the storage unit 250 or may be an external storage medium (e.g., a secure digital (SD) card or a hard disk (HD)), a server, or the like. The presentation apparatus 30 can be sent, for example, via the communication unit 210.

It should be noted that in a case where input waveform data is generated for different users (e.g., for children, for elderly people, for specific users), input waveform data associated with user identification information can be output.

Moreover, in a case where the presentation apparatus 30 has difficulty reproducing the pseudo shutter vibration due to a device or system factor, the output control unit 224 may inform the presentation apparatus 30 of a proposed improvement. For example, in a case of a device factor of the presentation apparatus 30 (e.g., no vibration unit provided, insufficient specifications of the vibration unit), the output control unit 224 may suggest an external attachment or output the best combination (not only vibration, but also sound output, pressure, rotation, electrostatic tactile stimulation, and the like) that can be output by the current device. Moreover, in a case of a system factor of the presentation apparatus 30 (e.g., exceeding the influence threshold value), the output control unit 224 may output a message that the camera shake or the like may be affected or may output a shutter sound obtained from the camera 10.

### (Operation Input Unit 230)

The operation input unit 230 receives an operation from the user and outputs input information to the control unit 220. The operation input unit 230 can be realized by various input devices such as a touch panel, a button, a switch, and a keyboard.

### (Display Unit 240)

The display unit 240 has a function of displaying various screens such as an operation screen. The display unit 240 can be realized by, for example, a liquid-crystal display (LCD) device or an organic light-emitting diode (OLED) device.

### (Storage Unit 250)

The storage unit 250 is realized by a read only memory (ROM) for storing programs, calculation parameters, or the like to be used for processing by the control unit 220, and a random access memory (RAM) for temporarily storing variable parameters as appropriate. The storage unit 250 according to the present embodiment is capable of storing various parameters of the camera 10, various parameters of the presentation apparatus 30, vibration data (acceleration data) of the shutter of the camera 10, generated input waveform data, and the like.

Hereinabove, the concrete description of the configuration of the generation apparatus 20 has been described.

It should be noted that the configuration of the generation apparatus 20 according to the present embodiment is not limited to the example shown in FIG. 2. For example, the generation apparatus 20 may be realized by a plurality of apparatuses. Moreover, at least some functions of the control unit 220 may be realized by the presentation apparatus 30 or a server on a network (not shown). Moreover, the generation apparatus 20 may be configured without the operation input unit 230 and the display unit 240. Moreover, the generation apparatus 20 may be an apparatus integrated with the presentation apparatus 30.

### 2-2. Configuration of Presentation Apparatus 30

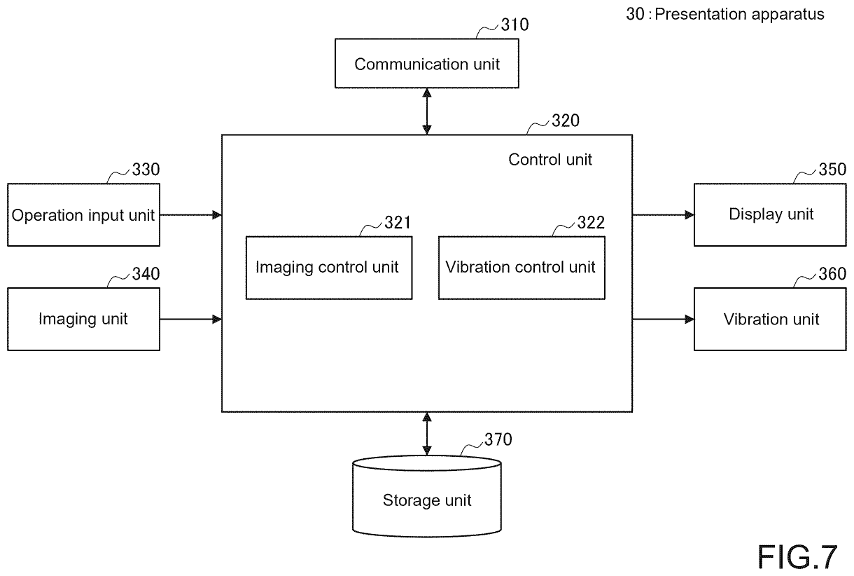

FIG. 7 is a block diagram showing an example of a configuration of the presentation apparatus 30 according to the present embodiment. As shown in FIG. 7, the presentation apparatus 30 includes a communication unit 310, a control unit 320, an operation input unit 330, an imaging unit 340, the display unit 350, a vibration unit 360, and a storage unit 370.

### (Communication Unit 310)

The communication unit 310 is connected to an external device and transmits/receives data. For example, the communication unit 310 receives input waveform data from the generation apparatus 20. Moreover, the communication unit 310 can be connected to a network for communication via, for example, wired/wireless local area network (LAN), Wi-Fi (registered trademark), Bluetooth (registered trademark), mobile communication network (long term evolution (LTE)), 3rd generation mobile communication method (3G)), 4th generation mobile communication system (4G), or 5th generation mobile communication system (5G)).

### (Control Unit 320)

The control unit 320 functions as an arithmetic processor and a controller and controls the overall operation in the presentation apparatus 30 in accordance with various programs. The control unit 220 is realized by electronic circuits such as central processing unit (CPU) and microprocessor. Moreover, the control unit 220 may include a read only memory (ROM) for storing the programs and calculation parameters to be used and a random access memory (RAM) for temporarily storing variable parameters as appropriate.

Moreover, the control unit 320 also functions as an imaging control unit 321 and a vibration control unit 322.

The imaging control unit 321 controls imaging by the imaging unit 340. For example, the imaging control unit 321 starts an arbitrary camera application in accordance with a user operation and displays an imaging screen (a through image obtained from the imaging unit 340) on the display unit 350.

Moreover, the imaging control unit 321 recognizes a timing when a shutter button displayed on the display unit 350 is tapped as a shutter timing, acquires a captured image from the imaging unit 340, and saves it.

The vibration control unit 322 performs control to present pseudo shutter vibration through the vibration unit 360 by using the generated input waveform data in accordance with the shutter timing (acquisition timing of the captured image) in the imaging unit 340. Moreover, the vibration control unit 322 may identify the user and use the input waveform data associated with the user in advance. Even in a case where the presentation apparatus 30 is shared by a plurality of users (e.g., family members), it is possible to present different shutter feelings to each user. The input waveform data to be used for each user may be pre-selected by displaying a selection screen on the display unit 350. Moreover, the input waveform data pre-selected by the user in the generation apparatus 20 may be used.

### (Operation Input Unit 330)

The operation input unit 330 receives an operation from the user and outputs input information to the control unit 320. The operation input unit 330 can be realized by various input devices such as a touch panel, a button, a switch, and a keyboard.

### (Imaging Unit 340)

The imaging unit 340 has a function of imaging a subject. The imaging unit 340 includes one or more lenses and an image sensor, acquires a signal from the image sensor according to the shutter timing, and generates an image. The generated image is stored in the storage unit 370. It should be noted that the subject to be imaged by the imaging unit 340 is not limited to a real object, but it may be a virtual object (e.g., an AR image). The imaging unit 340 according to the present embodiment may function as an augmented reality (AR) camera.

### (Display Unit 350)

The display unit 350 has a function of displaying various screens such as an operation screen. The display unit 350 can be realized by, for example, a liquid-crystal display (LCD) device or an organic light-emitting diode (OLED) device.

### (Vibration Unit 360)

The vibration unit 360 has a function of presenting vibration as a tactile stimulus. The structure of the vibration unit 360 is not particularly limited, but it can be realized by a linear resonant actuator (LRA), a voice coil motor (VCM), an eccentric rotating mass (ERM), a piezoelectric element, or the like.

### (Storage Unit 370)

The storage unit 370 is realized by a read only memory (ROM) for storing programs, calculation parameters, or the like to be used for processing by the control unit 320, and a random access memory (RAM) for temporarily storing variable parameters as appropriate.

Hereinabove, the concrete description of the configuration of the presentation apparatus 30 has been described. It should be noted that the presentation apparatus 30 according to the present embodiment is not limited to the example shown in FIG. 7. For example, the presentation apparatus 30 may be realized by a plurality of devices. Moreover, at least some components of the presentation apparatus 30 may be provided in an external device. Moreover, the presentation apparatus 30 may be an apparatus integrated with the generation apparatus 20.

Moreover, the display unit 350 may be realized as a head-mounted display (HMD) worn on the user's head. In this case, the imaging unit 340 is provided on the HMD facing outward, and the user's field of view becomes the imaging range. Moreover, in this case, the vibration unit 360 may be provided in the presentation apparatus 30 (e.g., a smartphone) that is connected to the HMD and carried by the user or the vibration unit 360 may be provided in the HMD or a separate shutter release button (a remote controller held by the user).

### 3. Operation Processing

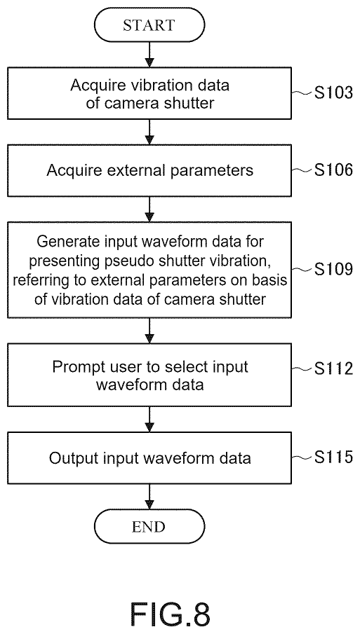

Next, operation processing of the presentation system according to the present embodiment will be specifically described in detail with reference to the drawings. FIG. 8 is a flowchart showing an example of a flow of processing of generating input waveform data according to the present embodiment.

As shown in FIG. 8, the data acquisition unit 221 of the generation apparatus 20 first acquires vibration data of the shutter of the camera 10 (Step S103). For example, in a case where the user wishes to reproduce the shutter vibration of the camera 10 (e.g., a single-lens reflex camera with a mechanical shutter) with the presentation apparatus 30 (e.g., a digital camera with an electronic shutter), the user performs an operation of inputting the vibration data (e.g., acceleration data) of the shutter of the camera 10 into the generation apparatus 20 by operating the generation apparatus 20 (e.g., a smartphone).

Next, the data acquisition unit 221 acquires external parameters to be used for generating input waveform data (Step S106).

Subsequently, the input waveform data generation unit 222 generates input waveform data for presenting the pseudo shutter vibration, referring to the external parameters (parameters including the weight of the camera 10 and the presentation apparatus 30) on the basis of the vibration data of the shutter of the camera (Step S109). Not limited to reproducing the shutter vibration of the camera 10, the generation apparatus 20 may acquire the user's preference (e.g., determination of acceleration axis to be used, specification of an impression of a shutter feeling) as the external parameters and generate input waveform data for presenting shutter vibration according to the user's preference.

Subsequently, the selection unit 223 displays a screen prompting the user to select input waveform data on the display unit 240 in a case where the input waveform data generation unit 222 has generated a plurality of pieces of input waveform data (Step S112). Whether the user selects the input waveform data or the generation apparatus 20 automatically determines (automatically generates a single piece of input waveform data) can be set in advance.

Subsequently, the output control unit 224 outputs the selected (determined) input waveform data to the storage destination or the presentation apparatus 30 (Step S115). Then, this operation is terminated.

Hereinabove, the example of the flow of processing of generating input waveform data according to the present embodiment has been described. It should be noted that the generation processing shown in FIG. 8 is an example, and the present disclosure is not limited thereto. For example, in a case where the generation apparatus 20 and the presentation apparatus 30 are integrated (e.g., a smartphone wished to reproduce shutter vibration also generates input waveform data), the input waveform data can be stored in the memory unit in Step S115 above.

### 4. Modified Examples

Next, a modified example of the present embodiment will be described.

### 4-1. Presentation of Shutter Sound

A presentation apparatus 30 according to a modified example of the present embodiment may be controlled to output a shutter sound along with the presentation of the pseudo shutter vibration. The presentation apparatus 30 further includes an audio output unit and outputs a pseudo shutter sound through the audio output unit in accordance with the shutter timing. The pseudo shutter sound may be associated with input waveform data for presenting the pseudo shutter vibration. The presentation apparatus 30 outputs the shutter sound associated with the input waveform data for presenting the pseudo shutter vibration in accordance with the shutter timing. This allows not only the pseudo shutter vibration but also the shutter sound to be presented, thus enhancing the emotional value of the user. It should be noted that a vibration unit 360 (e.g., a piezoelectric element) may be used for the sound output unit. In a case where the vibration unit 360 has a wide frequency band, it can also generate sound.

As the shutter sound, an actual sound (shutter sound) of a camera 10 when the shutter is released may be captured by a microphone. The microphone for sound acquisition may be an internal sensor of the camera 10 or an external sensor. Moreover, for sound acquisition, the camera 10 or the sound acquisition apparatus may inform the user of an ambient environmental sound (noise level) and recommend the user to perform sound acquisition in a quiet environment. The shutter sound (audio data) to be acquired may be a signal including a plurality of channels, such as stereo channels.

### 4-2. Presentation of Shutter Sound Corresponding to Subject Type

The shutter sound may be prepared for each subject type. The generation apparatus 20 is capable of modifying the waveform of the shutter sound acquired from the camera 10 (e.g., changing or adding tone, volume, sound type) and generating a shutter sound for each subject type. For example, the subject type includes models, children, adults, elderly people, men, women, one person, a plurality of people, and the like. More particularly, for a model, a luxurious shutter sound, for a child, a shutter sound that attracts children's interest, and the like are assumed.

The presentation apparatus 30 performs control to output the shutter sound corresponding to the subject type through the sound output unit when an imaging unit 340 captures an image. The subject type may be determined by image recognition (of a through image) in the presentation apparatus 30. Moreover, the subject type may be specified by the user in the presentation apparatus 30. It should be noted that the presentation apparatus 30 may control the shutter sound to be silent in a case where the subject is an animal, so as not to startle it with sound.

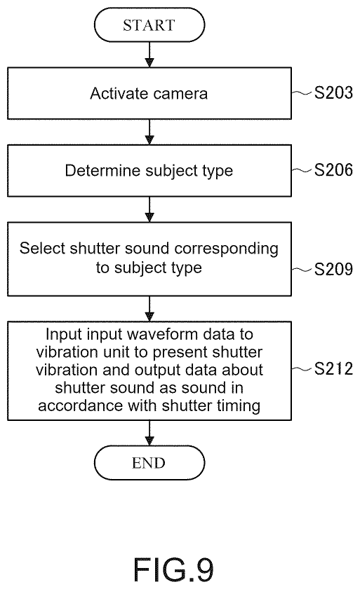

Hereinafter, operation processing according to this modified example will be described with reference to FIG. 9. FIG. 9 is a flowchart showing an example of processing of outputting the shutter sound corresponding to the subject type according to the modified example of the present embodiment.

As shown in FIG. 9, an imaging control unit 321 of the presentation apparatus 30 first activates the camera (imaging unit 340) (Step S203).

Subsequently, the control unit 320 determines the subject type by image recognition based on the data acquired from the imaging unit 340 (image data acquired from the image sensor before imaging, e.g., a through image) (Step S206).

Subsequently, the control unit 320 selects the shutter sound corresponding to the subject type (Step S209). For example, a single piece of input waveform data may be associated with a plurality of shutter sounds (e.g., a normal shutter sound and a shutter sound for a specific subject type). Moreover, a shutter sound for a specific subject type may be prepared regardless of input waveform data to be used.

Subsequently, the control unit 320 performs control to input the input waveform data to the vibration unit 360 to present the shutter vibration and output data about the selected shutter sound through the audio output unit in accordance with the shutter timing (Step S212). Then, this operation is terminated.

Hereinabove, the flow of the output processing of the shutter sound has been described. The operation processing shown in FIG. 9 is an example, and the present disclosure is not limited thereto.

Moreover, the presentation apparatus 30 may control the volume of the shutter sound in accordance with a focus position (a position in focus) in the imaging unit 340. Specifically, the presentation apparatus 30 may increase the shutter sound volume by a certain degree in a case where a distance from the imaging unit 340 (camera) to the focus position (focal length, typically a distance to the subject), which is obtained on the basis of the focus position, is equal to or greater than a predetermined value. This makes it possible to hear the shutter sound even when the subject is far away. Moreover, the presentation apparatus 30 may increase the volume of the shutter sound step by step in accordance with the focus position (specifically, the focal length).

### 4-3. Generation of Input Waveform Data Based on Shutter Sound

An input waveform data generation unit 222 of the generation apparatus 20 may generate input waveform data on the basis of an acquired shutter sound. That is, an audio signal may be used as the vibration data of the shutter of the camera 10 to be used for generating input waveform data. For example, the input waveform data generation unit 222 may simulate the corresponding acceleration data from an analysis result (frequency characteristics) of the shutter sound and generate input waveform data on the basis of such acceleration data.

### 4-4. Modified Example of Camera 10

In the embodiment described above, the camera 10 has the mechanical shutter, but the present embodiment is not limited thereto. For example, the camera 10 may be an apparatus that presents shutter vibration in a pseudo manner through the vibration unit. Also in such a case, the vibration data of the shutter of the camera 10 is acquired by the various sensors.

### 5. Supplement

Although the favorable embodiments of the present disclosure have been described in detail with reference to the accompanying drawings, the present technology is not limited to such examples. It is clear that a person having ordinary knowledge in the technical field of the present disclosure can conceive of various examples of changes or modifications within the scope of the technical ideas defined in the scope of claims, which are naturally understood to be within the technical scope of the present disclosure.

Moreover, one or more computer programs can also be created to make the hardware such as CPU, ROM, and RAM built in the camera 10, the generation apparatus 20, or the presentation apparatus 30 described above perform the functions of the camera 10, the generation apparatus 20, or the presentation apparatus 30. Moreover, a computer-readable storage medium in which such one or more computer programs are stored is also provided.

Moreover, the effects described herein are merely illustrative or exemplary, not limitative. In other words, the technology of the present disclosure can produce, together with or instead of the above effects, other effects which are obvious to those skilled in the art from the description herein.

It should be noted that the present technology can also take the following configurations.
(1) An information processing apparatus, including
   a control unit that performs, on the basis of vibration data of a shutter of an imaging apparatus from which the vibration data is acquired, control to generate input waveform data of pseudo shutter vibration to be presented in a target apparatus by referring to a parameter of the target apparatus.
(2) The information processing apparatus according to (1), in which
   the input waveform data is a signal to be used for driving a vibration unit provided in the target apparatus.
(3) The information processing apparatus according to (2), in which
   the parameter of the target apparatus includes at least a weight of the target apparatus or specification data of the vibration unit.
(4) The information processing apparatus according to (3), in which
   the specification data includes at least one of frequency characteristics, a rated voltage, a direction of vibration, or a used frequency band.
(5) The information processing apparatus according to any one of (2) to (4), in which
   the vibration data is acceleration data obtained by sensing the imaging apparatus.
(6) The information processing apparatus according to (5), in which
   the control unit processes the acceleration data acquired from the imaging apparatus by referring to the parameter of the imaging apparatus and the parameter of the target apparatus and generates, from the processed acceleration data, the input waveform data for reducing a shutter feeling of the imaging apparatus in the target apparatus.
(7) The information processing apparatus according to (5), in which
   the control unit processes frequency characteristics obtained by frequency analysis of the acceleration data acquired from the imaging apparatus by referring to the parameter of the imaging apparatus and the parameter of the target apparatus and generates, from the processed frequency characteristics, the input waveform data for reducing the shutter feeling of the imaging apparatus in the target apparatus.
(8) The information processing apparatus according to (6) or (7), in which
   the parameter of the imaging apparatus includes at least one of a weight, a structure, or a lens type of the imaging apparatus.
(9) The information processing apparatus according to any one of (6) to (8), in which
   the control unit uses data about a particular acceleration axis selected by a user as the acceleration data.
(10) The information processing apparatus according to any one of (1) to (9), in which
   the control unit further generates the input waveform data in a range below the influence threshold value by referring to an influence threshold value of the target apparatus.
(11) The information processing apparatus according to (10), in which
   the control unit changes intensity of the vibration, a direction of vibration, a used frequency band, a duration of vibration, or an effect in the input waveform data to be lower than the influence threshold value.
(12) The information processing apparatus according to any one of (1) to (11), in which
   the control unit changes intensity of vibration, a direction of vibration, a used frequency band, a duration of vibration, or an effect in the input waveform data on the basis of an age or medical condition of a user.
(13) The information processing apparatus according to any one of (1) to (12), in which
   the control unit generates a plurality of pieces of the input waveform data and determines input waveform data to be used in the target apparatus in accordance with selection by a user.
(14) The information processing apparatus according to any one of (1) to (13), in which
   the control unit
      performs control to display a screen for specifying an impression of a shutter feeling, and
      generates the input waveform data in accordance with the impression specified by a user.
(15) The information processing apparatus according to any one of (1) to (14), in which
   the information processing apparatus is the target apparatus, further including:
   an imaging unit; and
   a vibration unit, in which
   the control unit performs control to present pseudo shutter vibration through the vibration unit by using the generated input waveform data in accordance with a shutter timing in the imaging unit.
(16) The information processing apparatus according to (15), further including
   an audio output unit, in which
   the control unit further performs control to output a pseudo shutter sound from the audio output unit in accordance with the shutter timing, the pseudo shutter sound being generated on the basis of a shutter sound acquired from the imaging apparatus.
(17) The information processing apparatus according to (16), in which
   the control unit performs control to output the shutter sound corresponding to a subject type from the audio output (18) An information processing method, including by a processor,
   performing, on the basis of vibration data of a shutter of an imaging apparatus from which the vibration data is acquired, control to generate input waveform data of pseudo shutter vibration to be presented in a target apparatus by referring to a parameter of the target apparatus.
(19) A program that causes a computer to function as
   a control unit that performs, on the basis of vibration data of a shutter of an imaging apparatus from which the vibration data is acquired, control to generate input waveform data of pseudo shutter vibration to be presented in a target apparatus by referring to a parameter of the target apparatus.

### REFERENCE SIGNS LIST

10 camera
20 generation apparatus
210 communication unit
220 control unit
221 data acquisition unit
222 input waveform data generation unit
223 selection unit
224 output control unit
230 operation input unit
240 display unit
250 storage unit
30 presentation apparatus
310 communication unit
320 control unit
321 imaging control unit
322 vibration control unit
330 operation input unit
340 imaging unit
350 display unit
360 vibration unit
370 storage unit

1. An information processing apparatus, comprising
a control unit that performs, on a basis of vibration data of a shutter of an imaging apparatus from which the vibration data is acquired, control to generate input waveform data of pseudo shutter vibration to be presented in a target apparatus by referring to a parameter of the target apparatus.

2. The information processing apparatus according to claim 1, wherein
the input waveform data is a signal to be used for driving a vibration unit provided in the target apparatus.

3. The information processing apparatus according to claim 2, wherein
the parameter of the target apparatus includes at least a weight of the target apparatus or specification data of the vibration unit.

4. The information processing apparatus according to claim 3, wherein
the specification data includes at least one of frequency characteristics, a rated voltage, a direction of vibration, or a used frequency band.

5. The information processing apparatus according to claim 2, wherein
the vibration data is acceleration data obtained by sensing the imaging apparatus.

6. The information processing apparatus according to claim 5, wherein
the control unit processes the acceleration data acquired from the imaging apparatus by referring to the parameter of the imaging apparatus and the parameter of the target apparatus and generates, from the processed acceleration data, the input waveform data for reducing a shutter feeling of the imaging apparatus in the target apparatus.

7. The information processing apparatus according to claim 5, wherein
the control unit processes frequency characteristics obtained by frequency analysis of the acceleration data acquired from the imaging apparatus by referring to the parameter of the imaging apparatus and the parameter of the target apparatus and generates, from the processed frequency characteristics, the input waveform data for reducing the shutter feeling of the imaging apparatus in the target apparatus.

8. The information processing apparatus according to claim 6, wherein
the parameter of the imaging apparatus includes at least one of a weight, a structure, or a lens type of the imaging apparatus.

9. The information processing apparatus according to claim 6, wherein
the control unit uses data about a particular acceleration axis selected by a user as the acceleration data.

10. The information processing apparatus according to claim 1, wherein
the control unit further generates the input waveform data in a range below the influence threshold value by referring to an influence threshold value of the target apparatus.

11. The information processing apparatus according to claim 10, wherein
the control unit changes intensity of the vibration, a direction of vibration, a used frequency band, a duration of vibration, or an effect in the input waveform data to be lower than the influence threshold value.

12. The information processing apparatus according to claim 1, wherein
the control unit changes intensity of vibration, a direction of vibration, a used frequency band, a duration of vibration, or an effect in the input waveform data on a basis of an age or medical condition of a user.

13. The information processing apparatus according to claim 1, wherein
the control unit generates a plurality of pieces of the input waveform data and determines input waveform data to be used in the target apparatus in accordance with selection by a user.

14. The information processing apparatus according to claim 1, wherein
the control unit
performs control to display a screen for specifying an impression of a shutter feeling, and
generates the input waveform data in accordance with the impression specified by a user.

15. The information processing apparatus according to claim 1, wherein
the information processing apparatus is the target apparatus, further comprising:
an imaging unit; and
a vibration unit, wherein
the control unit performs control to present pseudo shutter vibration through the vibration unit by using the generated input waveform data in accordance with a shutter timing in the imaging unit.

16. The information processing apparatus according to claim 15, further comprising
an audio output unit, wherein
the control unit further performs control to output a pseudo shutter sound from the audio output unit in accordance with the shutter timing, the pseudo shutter sound being generated on a basis of a shutter sound acquired from the imaging apparatus.

17. The information processing apparatus according to claim 16, wherein
the control unit performs control to output the shutter sound corresponding to a subject type from the audio output

18. An information processing method, comprising
by a processor,
performing, on a basis of vibration data of a shutter of an imaging apparatus from which the vibration data is acquired, control to generate input waveform data of pseudo shutter vibration to be presented in a target apparatus by referring to a parameter of the target apparatus.

19. A program that causes a computer to function as
a control unit that performs, on a basis of vibration data of a shutter of an imaging apparatus from which the vibration data is acquired, control to generate input waveform data of pseudo shutter vibration to be presented in a target apparatus by referring to a parameter of the target apparatus.
